(19) United States
(12) Patent Application Publication
(10) Pub. No.: US 2022/0114304 A1
(43) Pub. Date: Apr. 14, 2022

(54) COMPUTER-AIDED DESIGN (CAD) BASED SENSOR DESIGN AND ANALYSIS

(71) Applicant: Siemens Industry Software Inc., Plano, TX (US)

(72) Inventor: John O'Connor, East Greenwich, RI (US)

(21) Appl. No.: 17/424,252

(22) PCT Filed: Feb. 8, 2019
(86) PCT No.: PCT/US2019/017202

§ 371 Date: Jul. 20, 2021

(51) Int. Cl. G06F 30/20

(52) U.S. Cl. CPC G06F 30/20; G06F 2111/04

(57) ABSTRACT

Systems, methods, logic, and devices may support computer-aided design (CAD) based sensor design and analysis. In some examples, a system may include a sensor design engine and a sensor analysis engine. The sensor design engine may be configured to access a CAD model of a part and define a sensor in the CAD model as a component of the part, including by specifying: design parameters for the sensor, manufacturing constraints for physical construction of the part including the sensor; and a signal type produced by the sensor. The sensor analysis engine may be configured to perform a simulation analysis on the part defined in the CAD model to include the sensor, including digitally simulating operation of the sensor as a component of the part.

### BACKGROUND

Computer systems can be used to create, use, and manage data for products and other items. Examples of computer systems include computer-aided design (CAD) systems (which may include computer-aided engineering (CAE) systems), visualization and manufacturing systems, product data management (PDM) systems, product lifecycle management (PLM) systems, and more. These systems may include components that facilitate the design and simulated testing and manufacture of product structures.

### SUMMARY

Disclosed implementations include systems, methods, devices, and logic that support CAD-based sensor design and analysis, including for parts designed for construction via additive manufacturing or composite layup.

In one example, a method may be performed, executed, or otherwise carried out by a computing system. The method may include accessing a CAD model of a part and defining a sensor in the CAD model as a component of the part, including by specifying design parameters for the sensor, manufacturing constraints for physical construction of the part including the sensor; and a signal type produced by the sensor. The method may also include performing a simulation analysis on the part, defined in the CAD model to include the sensor, including digitally simulating operation of the sensor as a component of the part.

In another example, a system may include a sensor design engine and a sensor analysis engine. The sensor design engine may be configured to access a CAD model of a part and define a sensor in the CAD model as a component of the part, including by specifying design parameters for the sensor, manufacturing constraints for physical construction of the part including the sensor, and a signal type produced by the sensor. The sensor analysis engine may be configured to perform a simulation analysis on the part, defined in the CAD model to include the sensor, including digitally simulating operation of the sensor as a component of the part.

In yet another example, a non-transitory machine-readable medium may store instructions executable by a processor. Upon execution, the instructions may cause the processor or a computing system to access a CAD model of a part, define a sensor in the CAD model as a component of the part, including by specifying manufacturing constraints for physical construction of the part including the sensor, and perform a simulation analysis on the part, defined in the CAD model to include the sensor, including digitally simulating operation of the sensor as a component of the part.

### BRIEF DESCRIPTION OF THE DRAWINGS

Certain examples are described in the following detailed description and in reference to the drawings.

FIG. 1 shows an example of a computing system that supports CAD-based sensor design and analysis.

FIG. 2 shows an example sensor definition by a sensor design engine for an additive part designed for construction through additive manufacturing.

FIG. 3 shows an example sensor definition by the sensor design engine for a composite part designed for construction through composite layup.

FIG. 4 shows an example sensor simulation by a sensor analysis engine.

FIG. 5 shows an example of logic that a system may implement to support CAD-based sensor design and analysis.

FIG. 6 shows an example of a system that supports CAD-based sensor design and analysis.

### DETAILED DESCRIPTION

The discussion below refers to sensors, which may include any device that detects or measures a property, including but not limited to temperature, pressure, electrical current, acceleration, proximity, light waves, chemical compositions, and many more. Sensors may be physically embedded in parts (e.g., product structures) to monitor physical properties or behavior of the part. Sensor technology is becoming increasingly prevalent in multiple facets of modern society, including through internet of things (IoT) sensing systems and networks. As examples, sensors can be used to monitor automotive braking systems, electrical appliance functionalities, parking lot occupancies, soil characteristics for farming systems, biological tissue behaviors through medical diagnostic equipment, on-chip thermal conditions for high-performance computing systems, or for near-countless other applications

As a particular example, sensors may be inserted in additive parts, which may refer to any part that is designed for physical construction via additive manufacturing. Additive manufacturing (which can encompass 3D printing) may be performed through use of 3D printers to construct objects through material deposition. Sensors may be integrated into an additive part during 3D construction. Sensors may be inserted at certain positions of an additive part, e.g., within a particular deposition layer or on a surface of the additive part, to monitor physical characteristics of the composite part. However, present sensor insertion techniques for additive parts are limited to manual access during 3D printing or afterwards. Present design capabilities for additive parts with integrated sensors is limited, and 3D manufacturing planning often fails to account for sensor positioning, geometries, and use.

Sensors may also be inserted into composite parts (also referred to as composite laminates), which may refer to any object or structure that is composed of multiple layers of material (e.g., plies). Composite parts may be formed by sequentially layering ply upon ply to construct the composite part or composite laminate, often times through use of a composite part layup tool. Composite parts may support insertion of a core (also referred to as core material) to alter the physical properties of the composite part, e.g., to control the thickness, stiffness, moment of inertia, thermal characteristics, impact resistance, weight distribution, load bearing capability, or various other composite part characteristics. Sensors may be inserted at certain positions of a composite part, e.g., at a specific ply layer or on the core, to monitor physical characteristics of the composite part. As with additive parts, sensor insertion and design for composite parts is limited, error-prone, and fails to account for sensor design and insertion during design phases.

The disclosure herein may provide systems, methods, devices, and logic for CAD-based sensor design and analysis. The various features described herein may provide capabilities to define sensors in CAD models, including CAD models for additive parts and composite parts. As used herein, sensors defined in a CAD model may take the form of a digital representation of a physical sensor to be embedded or integrated as a component of a constructed part. In that regard, sensors may be components of parts in that the sensors can be removably or irremovably included as an element of a part.

By supporting actual, precise, and intelligent insertion of sensors (e.g., digital sensor representations) into CAD models, additive parts and composite parts can be designed and analyzed with increased precision, flexibility, and capability. Moreover, various CAD-based sensor analysis features are disclosed herein by which operation of sensors defined in CAD models can be digitally simulated and provide computer-aided engineering (CAE) capabilities for inserted sensors. As such, digital simulations at sensor positions may provide increased feedback at specific part positions, which may drive part design changes and optimizations, providing such benefits prior to physical construction.

These and other benefits of the CAD-based sensor design and analysis features are described in greater detail herein.

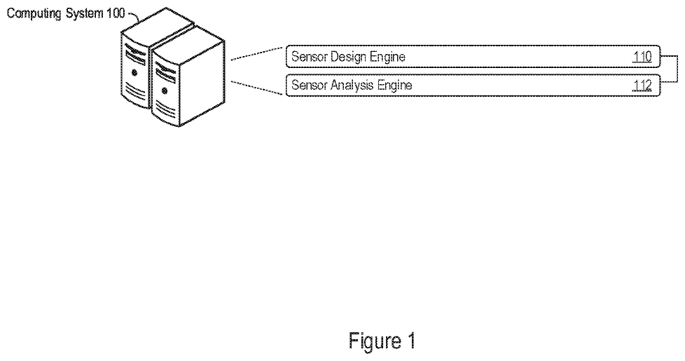

FIG. 1 shows an example of a computing system 100 that supports CAD-based sensor design and analysis. The computing system 100 may include a single or multiple computing devices such as application servers, compute nodes, desktop or laptop computers, smart phones or other mobile devices, tablet devices, embedded controllers, and more. In some examples, the computing system 100 implements a CAD tool or CAD program through which a user may design and simulate testing and manufacture of product structures, including additive parts and composite parts.

As described in greater detail herein, the computing system 100 may provide CAD-based sensor design and analysis capabilities. In that regard, the computing system 100 may support product/part design in CAD models that include sensors defined and positioned within the CAD model itself. Sensor definitions supported by the computing system 100 may include various design parameters that specify physical characteristics or requirements of the sensor, manufacturing constraints that may specify limitations of the sensor during construction of the part that the sensor is a component of, or signal types indicative of the output of the sensors. In some implementations, the computing system 100 may enforce specific constraints or parameters in defining sensors in a CAD model, for example with respect to specific physical or manufacturing characteristics required for an additive part or a composite part. As also described herein, the computing system 100 may support various analysis (e.g., CAE-based) features for defined sensors, providing for digital simulation of defined sensors to analyze part behavior with increased detail and precision.

The computing system 100 may be implemented in various ways to provide any of the CAD-based sensor design and analysis features described herein. As an example implementation, the computing system 100 shown in FIG. 1 includes a sensor design engine 110 and a sensor analysis engine 112. The system 100 may implement the engines 110 and 112 (and components thereof) in various ways, for example as hardware and programming. The programming for the engines 110 and 112 may take the form of processor-executable instructions stored on a non-transitory machine-readable storage medium and the hardware for the engines 110 and 112 may include a processor to execute those instructions. A processor may take the form of single processor or multi-processor systems, and in some examples, the system 100 implements multiple engines using the same computing system features or hardware components (e.g., a common processor or a common storage medium).

In operation, the sensor design engine 110 may access a CAD model of a part and define a sensor in the CAD model as a component of the part, including by specifying design parameters for the sensor, manufacturing constraints for physical construction of the part including the sensor, and a signal type produced by the sensor. In operation, the sensor analysis engine 112 may perform a simulation analysis on the part, defined in the CAD model to include the sensor, including digitally simulating operation of the sensor as a component of the part.

These and other example CAD-based sensor design and analysis features according to the present disclosure are described in greater detail next. Many of the examples are described specifically with respect to additive parts and composite parts. However, any of the described CAD-based sensor design and analysis features may be consistently provided or implemented for other part types as well.

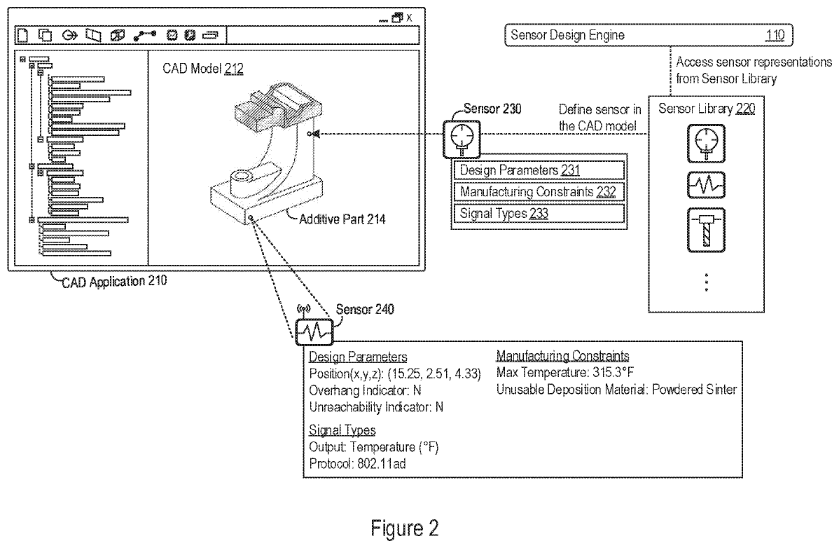

FIG. 2 shows an example sensor definition by the sensor design engine 110 for an additive part designed for construction through additive manufacturing. In FIG. 2, a CAD application 210 is depicted and may support the design of a CAD model 212 for an additive part 214.

The sensor design engine 110 may support design of sensors as components of the additive part 214. Although depicted as separate from the CAD application 210 in FIG. 2, some portions of the sensor design engine 110 (e.g., programming) may be implemented as a sub-component, module, or other element of the CAD application 210. In supporting sensor design in the CAD model 212, the sensor design engine 110 may define any number of sensors in the CAD model 212. As the CAD model 212 may provide a digital representation of a physical part (e.g., the additive part 214), sensors defined by the sensor design engine 110 in the CAD model 212 may be in a digital form (e.g., not physical). Defined sensors may be integrated as components of the additive part 214 itself, and the sensor design engine 110 may thus support in situ description of integrated sensors as digital components specified and recognized within the CAD model 212.

In some examples, the sensor design engine 110 may access a sensor library 220 to select a particular sensor design for insertion in the CAD model 212. The sensor library 220 may store different sets of predefined sensor representations, and may thus store sensors of various types, designs, structure, size, industrial applicability, etc. In some instances, the sensor library 220 stores sensor templates (e.g., distinguished according to sensor types) that the sensor design engine 110 may customize or further define, e.g., to meet a specific performance requirement or material constraint specific to the additive part 214. Additionally or alternatively, the sensor library 220 may store sensor representations previously designed or used by the CAD application 210, whether by a particular user, group of users, organization, or via open-source or shared design forums. The sensor library 220 may be separate (e.g., remote) from the sensor design engine 110 engine or implemented as a component thereof.

In the example shown in FIG. 2, the sensor design engine 110 defines the sensor 230 in the CAD model 212. In doing so, the sensor design engine 110 may specify different sensor characteristics for the sensor 230, including design parameters 231, manufacturing constraints 232, and signal types 233 specific for the sensor 230. These sensor characteristics are each described in turn.

Design parameters for a sensor defined by the sensor design engine 110 may refer to any design attribute of the sensor. Example sensor parameters may include sensor position values, sensor size or size thresholds (e.g., maximum sensor size for a particular part), power requirements, distance-to-surface rules, sensor components, and the like. In some implementations, design parameters may include effect indicators with respect to the part that a sensor is integrated into, and effect indicators may specify a physical change that the sensor will have on the part. Example effect indicators include increased weight, reduced stiffness, thermal limitations, center of gravity changes, etc.

Various example design parameters are shown in FIG. 2 using the sensor 240 as an illustrative example. Design parameters specific to the sensor 240 may include a location of the sensor (e.g., specified as coordinates in the CAD model 212) as well as an overhang indicator and unreachability indicator, which may be design parameters specific to additive parts. The overhang indicator may specify whether the sensor 240 will create or is located at an overhang upon 3D construction of the additive part 214. The sensor design engine 110 may perform an overhang detection process at the sensor position of the additive part 214 and set a value of the overhang indicator accordingly (shown in FIG. 2 as a “N” value indicative that the sensor 240 is not part of an overhang).

The unreachability indicator may specify whether a position of the sensor 240 in the additive part 214 is unreachable after construction of the additive part 214 through additive manufacturing. As such, the sensor design engine 110 may use various ray projection or mesh analysis techniques to determine whether sensor 240 is reachable from any opening in the additive part 214, and set a value of the unreachable indicator accordingly (also shown in FIG. 2 as a “N” value, and thus indicative that the sensor 240 is reachable upon 3D construction). Accordingly, the sensor design engine 110 may set various design parameters for sensors defined in the CAD model 212, some of which may be specific to additive parts.

Continuing the description of example design characteristics, the sensor design engine 110 may specify manufacturing constraints for sensors defined as components of a part. Manufacturing constraints may refer to any limitations for physical construction of a part that is embedded with a defined sensor. Example manufacturing constraints may include a threshold temperature or pressure values that the defined sensor can endure during part construction without sustaining damage or reducing operability. Other example manufacturing constraints may include specific construction materials, fibers, surfaces, or other physical characteristics that the defined sensor cannot be inserted upon during construction, e.g., to reduce or prevent sensor damage that impacts sensor functionality.

The sensor design engine 110 may specify manufacturing constraints specific to additive parts. For instance, the sensor design engine 110 may specify manufacturing constraints 232 for the sensor 230 that specify a pause point during physical construction of the additive part 214 for physical insertion of the sensor 230, e.g., at a specific deposition layer, timing in the 3D printing process, etc. Physical sensor insertion during additive manufacture may be accomplished by human interaction, preconfigured machines, or robotic systems.

As other examples, the sensor design engine 110 may specify temperature constraints (e.g., max temperature) for defined sensors to limit the construction of the additive part 214 through additive manufacturing or deposition material constraints that prohibit use of certain deposition materials during 3D construction of the additive part 214 via additive manufacturing. In the example shown in FIG. 2, the sensor 240 is defined by the sensor design engine 110 to include an “unusable deposition material” manufacturing constraint that indicates the sensor 240 is unusable when additive part 214 is designed to be constructed using powder sinter as a deposition material. While some specific examples of manufacturing constraints are presented, the sensor design engine 110 may specify any suitable manufacturing constraint applicable to a part modeled in a CAD model.

As yet another example sensor characteristic, the sensor design engine 110 may specify signal types for sensors defined as components of a part. Specified signal types may indicate an output signal produced by the sensor, including as a directly-measured physical value or as outputs correlated to a measured physical value. To illustrate, the sensor 240 shown in FIG. 2 may be defined to generate an output measuring temperature (° F.). The sensor design engine 110 may define the sensor 240 in the CAD model 212 so as to directly output a measured temperature value (e.g., 44.5° F.) or as a physical value that correlates to temperature (e.g., a voltage range from 0.0-3.5V which is directly or otherwise proportional to a temperature range 32.1° F.-125.2° F.). The specific output signal of a sensor (e.g., the sensor 230) and/or correlated range may be specified according to characteristics of existing physical sensors to be inserted or as customized by a user of the CAD application 210.

Additionally or alternatively, the signal types sensor characteristic may specify how a defined sensor communicates measured values. In that regard, the sensor design engine 110 may specify communication capabilities of a sensor, e.g., sensor communications via WiFi (e.g., 802.11xx) Bluetooth, hardwired, Ethernet, or any other suitable communication protocol. In the example shown in FIG. 2, the sensor design engine 110 configures the sensor 240 to transmit sensed temperature values via the 802.11ad communication protocol.

While some examples of sensor characteristics are presented above, the sensor design engine 110 may define a sensor in a CAD model according to any number of additional or alternative capabilities, features, parameters, configurations, or characteristics, any of which may be specific to additive parts, component parts, or other part types. Sensor characteristics of a defined sensor may be predetermined (e.g., specified as part of a sensor template or sensor representation in the sensor library 220), user-specified, or otherwise determined by the sensor design engine 110 itself.

In some implementations, the sensor design engine 110 enforces defined sensor characteristics in the CAD model 212. In doing so, the sensor design engine 110 may evaluate characteristics of a defined sensor, a part in the CAD model 212, or a combination of both to determine whether defined sensor characteristics are violated. For instance, a design parameter 231 of the sensor 230 may specify a minimum distance-to-surface value (e.g., 2.1 millimeters), and the sensor design engine 110 may flag or output a design violation when the sensor 230 is positioned at a location in the CAD model 212 with a distance to a surface of the additive part 214 that is less than minimum distance-to-surface value. Other example enforcements include flagging design violations when the additive part 214 (or a portion of which at which the sensor 230 is positioned) is comprised of a deposition material identified as unusable for the sensor 230, when the sensor 230 is positioned at or creates an overhang in the additive part 214, or when the sensor 230 violates a minimum or maximum distance-to-other-sensor constraint.

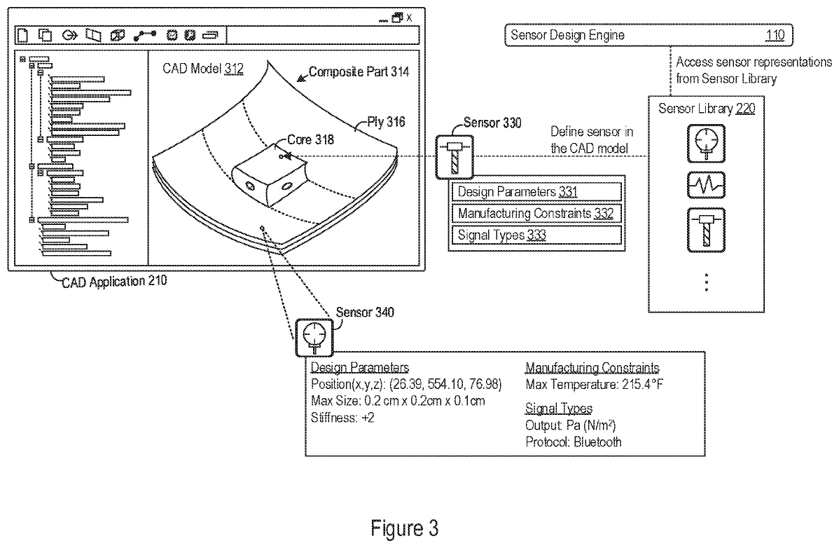

As described with respect to FIG. 2, the sensor design engine 110 may define sensors in a CAD model, and many of the defined sensor features may be specific to additive parts. In a consistent manner, the sensor design engine 110 may define sensors in a CAD model with features specific to composite parts, some examples of which are described next in connection with FIG. 3.

FIG. 3 shows an example sensor definition by the sensor design engine 110 for a composite part designed for construction through composite layup. In FIG. 3, the CAD application 210 is illustrated to support the design of a CAD model 312 for a composite part 314. Portions of the composite part 314 shown in FIG. 3 include a ply 316 (representing a particular layer of material in the composite part) and the core 318 (which may be designed and used to alter different physical characteristics of the composite part 314).

In a consistent manner as described in FIG. 2, the sensor design engine 110 may define sensors in the CAD model 312 for the composite part 314, including by accessing sensor representations from the sensor library 220. The sensor library 220 may store multiple predefined sensor representations with predefined design constraints, manufacturing constraints, and signal types. In FIG. 3, the sensor design engine 110 defines the sensor 330 in the CAD model 312, and in particular at surface position on the core 318 of the composite part 314. The sensor design engine 110 may specify design parameters 331, manufacturing constraints 332, and signal types 333 specific to the sensor 330 as well.

Some or all of the design parameters 331, manufacturing constraints 332, and signal types 333 specified for the sensor 330 may be composite part-specific. In that regard, the sensor design engine 110 may specify particular sensor characteristics that account for requirements, constraints, or features of composite parts and layup constructions.

In some examples, the sensor design engine 110 may specify design parameters for sensors that specify a threshold size (e.g., maximum) for the sensors or a physical alteration characteristic indicative of an effect of inserted sensors on physical behavior of the composite part 314. One example of such a feature is shown via the sensor 340 in FIG. 3, which includes a design parameter that increases the stiffness of the composite part 314 by +2 (e.g., as measured in milli-Newtons/meter, pounds/inch, or a customized stiffness measurement range supported by the CAD application 210). Other example effects by the sensor on the composite part 314 include effects on weight total, load bearing-capabilities, moment of inertia, thermal characteristics, impact resistance, weight distribution, or other physical characteristics of the composite part 314. In some instances, such design parameters may take the form of threshold (e.g., maximum or minimum) physical impacts that inserted sensors can have on the composite part 314.

With regards to composite part-specific manufacturing constraints, the sensor design engine 110 may specify threshold heat tolerances that limit use of a laminate resin pressurization process or composite curing process for construction of the composite part 314 through composite layup. Put another way, the sensor design engine 110 may set, as manufacturing constraints for defined sensors, limits on which particular heating, curing, or resin pressurization processes can be used to construct the composite part 314. Such manufacturing constraints may specify threshold environmental conditions upon which sensor performance or operability is damaged, declines, or ceases altogether. As an example illustrated in FIG. 3, the sensor 340 is defined to include a manufacturing constraint of a maximum temperature of 215.4° F. Such a temperature threshold may prevent use of particular resin pressurization or curing processes for construction of the composite part 314, or may otherwise indicate that the sensor will be impacted (e.g., destroyed) if such processes are used during construction of the composite part 314.

Accordingly, the sensor design engine 110 may enforce any number of composite part-specific design characteristics for sensors defined in the CAD model 312 for the composite part 314. In a consistent manner as described herein, the sensor design engine 110 may flag design violations when a characteristic of the composite part 314 (e.g., resin, ply locations, maximum stiffness, etc.) are not satisfied with regards to individual (or total) sensor characteristics of sensors defined in the CAD model 312.

In the various ways described herein, the sensor design engine 110 may support definition and insertion of sensors into CAD models. By supporting definition of sensors as a specific object type in CAD models, the sensor design engine 110 may support in situ description, placement, and design of sensors, including specifically for additive part designs and composite part designs. In comparison to CAD applications without such sensor description and definition capabilities, the sensor design engine 110 may support CAD model designs with increased precision, flexibility, and capability. Moreover, the sensor design engine 110 may support CAD modeling and designs that specifically account for the size, description, shape, weight, and physical characteristics of sensors during the design phase (as compared to manual physical sensor insertion separate from part design and manufacture). By doing so, the sensor design engine 110 may allow manufacturing plans to specifically account for embedded sensors during design phases, as opposed to post-construction sensor attachments that may not fit on constructed physical parts or function in a desired manner. Accordingly, the CAD-based sensor design features described herein may improve product design and manufacturing.

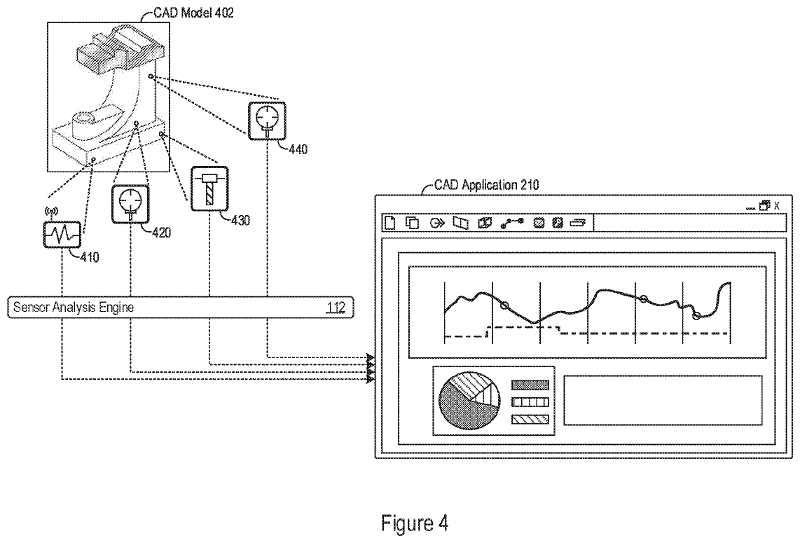

Sensors defined in CAD models may also provide increased analysis capabilities for CAD applications. Some example CAD-based sensor analysis features are described next with respect to FIG. 4.

FIG. 4 shows an example sensor simulation by the sensor analysis engine 112. In FIG. 4, the sensor analysis engine 112 performs a simulation analysis on a part modeled in a CAD model 402 to include the sensors 410, 420, 430, and 440. The sensor analysis engine 112 may digitally simulate operation of the sensors 410, 420, 430, and 440 as components of the part defined in the CAD model 402. In the specific example shown in FIG. 4, the sensor analysis engine 112 may output sensor simulations via the CAD application 210. Although depicted as separate from the CAD application 210 in FIG. 4, some portions of the sensor analysis engine 112 (e.g., programming) may be implemented as a sub-component, module, or other element of the CAD application 210. As such, the CAD application 210 (or other design tool) may provide various CAD model simulation capabilities.

In some implementations, the sensor analysis engine 112 digitally simulates operation of part (as designed in CAD model 402), sensors 410, 420, 430, and 440, or both via CAE analyses. Such CAE analysis features may be implemented as part of the CAD application 210. For instance, the sensor analysis engine 112 may transfer the sensors 410, 420, 430, and 440 defined in the CAD model 402 into a CAE model and capture simulation results at the part locations of the sensors 410, 420, 430, and 440. CAE simulations performed by the sensor analysis engine 112 for the sensors 410, 420, 430, and 440 (or the whole part as designed in the CAD model 402) may simulate various values during part manufacture (e.g., 3D deposition, composite layup) or part operation (e.g., simulated environment conditions). Example simulated values that the sensor analysis engine 112 may capture include thermal values, radiation, force, magnetic loading, structural strain, temperature (e.g., heat exposure), or various other physical effects the sensors 410, 420, 430, and 440 may be susceptible to at respective part positions.

In performing simulations for the sensors 410, 420, 430, and 440, the sensor analysis engine 112 may configure the simulation such that the sensors 410, 420, 430, and 440 may output simulated values based on the simulated manufacture or operation of a part. In that regard, the sensor analysis engine 112 may support digital simulation of physical behavior of the sensors as integrated into a part of the CAD model 402. In doing so, the sensor analysis engine 112 may support digital capture of various part behaviors and effects through specific sensors prior to physical manufacture. Such design and simulation capabilities may support identification of defects, inefficiencies, or issues during the design phase instead of after physical manufacture. As such, design issues detected during digital simulation can be addressed, for example via part redesigns in the CAD application 210. Such part redesigns may be costly, impractical, or at times impossible if detected after physical manufacture.

Moreover, sensor analysis features specific to additive parts and composite parts may be supported by the sensor analysis engine 112. For instance, CAE simulation of sensor behavior provided by the sensor analysis engine 112 may measure physical inputs and take into account topological optimizations that may occur in additive part designs. In such designs of additive parts, topology optimizations may alter the shape or geometry of additive parts at different design phases, and the CAE simulations by the sensor analysis engine 112 may detect the extent to which such geometry optimizations impact the additive part.

As an example, CAE simulations by the sensor analysis engine 112 may detect whether topology optimizations to an additive part cause the sensors 410, 420, 430, or 440 to fail, e.g., as one or more of the sensors 410, 420, 430, or 440 are now positioned outside of the optimized surface of the additive part (i.e., no longer integrated or embedded within the additive part, whether partially or in whole). As another example, CAE simulations by the sensor analysis engine 112 may determine whether topology optimizations now violate specific design constraints for the sensors 410, 420, 430, and 440, e.g., a distance-to-surface constraint is no longer met, the weight of the additive part is reduced past a minimum requirement for the sensors 410, 420, 430, or 440, etc. Additionally or alternatively, the sensor analysis engine 112 may detect defects in the additive part or violation of sensor constraints by identifying distorted sensor output signals or diminished sensor signal integrity through the CAE simulations.

For sensors embedded in composite parts, the sensor analysis engine 112 may perform CAE simulations of sensor behavior measuring physical inputs and account for composite laminate layer optimizations that may occur at different points in composite part design. Such laminate layer optimizations may change the physical characteristics of plies to meet certain criteria, e.g., a target weight distribution, stiffness, density, size, etc. In a similar manner as topology optimizations for additive parts, laminate layer optimizations for composite parts may impact sensor functionality. As such, the sensor analysis engine 112 may perform CAE simulations to determine whether the laminate layer optimizations cause the composite part to violate specific constraints for the sensors 410, 420, 430, and 440 (e.g., distance to surface requirements, manufacturing constraints, etc.)

In some implementations, the sensor analysis engine 112 may further utilize sensor simulations to drive IoT network simulations. To do so, the sensor analysis engine 112 may provide the CAE simulation results for the sensors 410, 420, 430, and 440 to a data manager (or other logical entity) that may drive a logical representation of an IoT system that includes the sensors 410, 420, 430, and 440 and multiple other sensors (e.g., as embedded in other additive parts, composite parts, or others). That is, the digital simulations of the CAD model 402 by the sensor analysis engine 112 may drive, at least in part, simulations of complex IoT systems with several other parts and sensors. Doing so may help design and create “smart” parts (e.g., as part of a complex IoT sensing system) that more accurately and effectively align and operate together.

As described herein, various CAD-based sensor analysis features may increase the capability by which CAD modeled parts can be designed, tested, and verified. By integrating and simulating sensors defined in CAD models, the CAD based sensor analysis features presented herein may improve part design and testing.

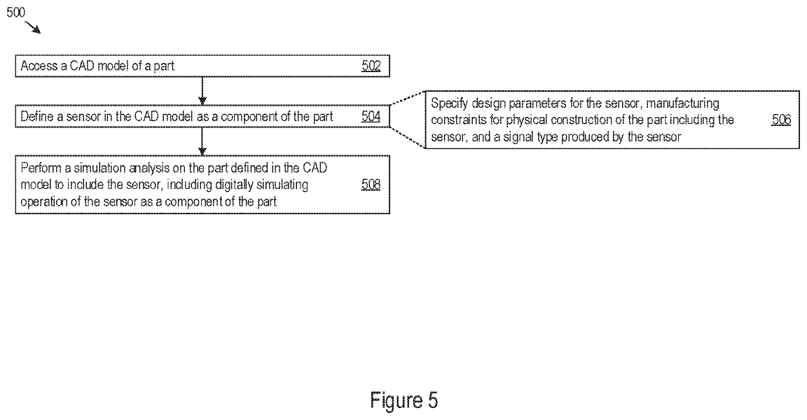

FIG. 5 shows an example of logic 500 that a system may implement to support CAD-based sensor design and analysis. For example, the computing system 100 may implement the logic 500 as hardware, executable instructions stored on a machine-readable medium, or as a combination of both. The computing system 100 may implement the logic 500 via the sensor design engine 110 and the sensor analysis engine 112, through which the computing system 100 may perform or execute the logic 500 as a method to support CAD-based sensor design and analysis. The following description of the logic 500 is provided using the sensor design engine 110 and the sensor analysis engine 112 as examples. However, various other implementation options by the computing system 100 are possible.

In implementing the logic 500, the sensor design engine 110 may access a CAD model of a part (502). Such access may include opening a CAD model file or by identifying a CAD model being loaded, used, or edited by a CAD application. The sensor design engine 110 may also define a sensor in the CAD model as a component of the part (504), including by specifying design parameters for the sensor, manufacturing constraints for physical construction of the part including the sensor, and a signal type produced by the sensor (506). The sensor design engine 110 may do so in any of the ways described herein, including specifying specific design characteristics for additive parts, composite parts, or both. In implementing the logic 500, the sensor analysis engine 112 may perform a simulation analysis on the part, defined in the CAD model to include the sensor, including digitally simulating operation of the sensor as a component of the part (508). The sensor analysis engine 112 may do so in any of the ways described herein, for instance via according to any of the various CAE simulation features described above.

The logic 500 shown in FIG. 5 provides an example by which a computing system 100 may support CAD-based sensor design and analysis. Additional or alternative steps in the logic 500 are contemplated herein, including according to any features described herein for the sensor design engine 110, the sensor analysis engine 112, or combinations of both.

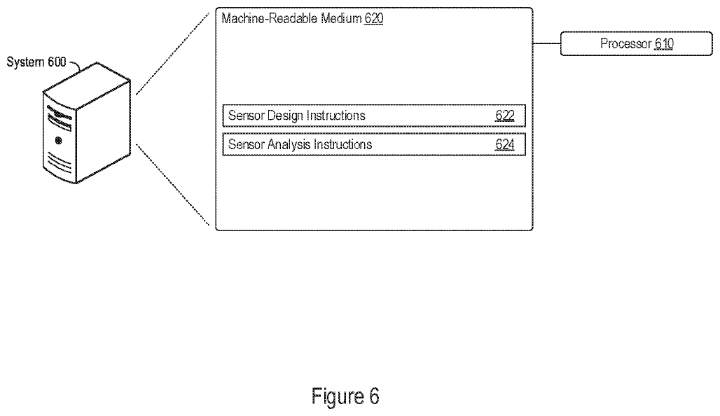

FIG. 6 shows an example of a system 600 that supports CAD-based sensor design and analysis. The system 600 may include a processor 610, which may take the form of a single or multiple processors. The processor(s) 610 may include a central processing unit (CPU), microprocessor, or any hardware device suitable for executing instructions stored on a machine-readable medium. The system 600 may include a machine-readable medium 620. The machine-readable medium 620 may take the form of any non-transitory electronic, magnetic, optical, or other physical storage device that stores executable instructions, such as the sensor design instructions 622 and the sensor analysis instructions 624 shown in FIG. 6. As such, the machine-readable medium 620 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The system 600 may execute instructions stored on the machine-readable medium 620 through the processor 610. Executing the instructions may cause the system 600 (or any other computing or CAD system) to perform any of the CAD-based sensor design and analysis features described herein, including according to any of the features with respect to the sensor design engine 110, the sensor analysis engine 112, or a combination of both.

For example, execution of the sensor design instructions 622 by the processor 610 may cause the system 600 to access a CAD model of a part and define a sensor in the CAD model as a component of the part, including by specifying manufacturing constraints for physical construction of the part including the sensor. Execution of the sensor analysis instructions 624 by the processor 610 may cause the system 600 to perform a simulation analysis on the part, defined in the CAD model to include the sensor, including digitally simulating operation of the sensor as a component of the part.

The systems, methods, devices, and logic described above, including the sensor design engine 110 and the sensor analysis engine 112, may be implemented in many different ways in many different combinations of hardware, logic, circuitry, and executable instructions stored on a machine-readable medium. For example, the sensor design engine 110, the sensor analysis engine 112, or combinations thereof, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine readable instructions stored on the medium, which when executed in an endpoint, computer system, or other device, cause the device to perform operations according to any of the description above, including according to any features of the sensor design engine 110, the sensor analysis engine 112, or combinations thereof.

The processing capability of the systems, devices, and engines described herein, including the sensor design engine 110 and the sensor analysis engine 112, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
by a computing system:
accessing a computer-aided design (CAD) model of a part;
defining a sensor in the CAD model as a component of the part, including by specifying:
design parameters for the sensor;
manufacturing constraints for physical construction of the part including the sensor; and
a signal type produced by the sensor; and
performing a simulation analysis on the part, defined in the CAD model to include the sensor, including digitally simulating operation of the sensor as a component of the part.

2. The method of claim 1, wherein defining the sensor in the CAD model comprises accessing a representation of the sensor from a sensor library that stores multiple predefined sensor representations, each with predefined design constraints, manufacturing constraints, and signal types.

3. The method of claim 1, wherein:
the part is designed for construction through additive manufacturing;
the design parameters specify a threshold size for the sensor, an overhang indicator specifying whether the sensor will create an overhang during construction of the part, an unreachability indicator specifying whether a position of the sensor in the part is unreachable after construction of the part through additive manufacturing, or any combination thereof; and
the manufacturing constraints for the sensor specify a pause point during the construction of the part for physical insertion of the sensor, a temperature constraint to limit the construction of the part through additive manufacturing, a deposition material constraint to limit the construction of the part through additive manufacturing, or any combination thereof.

4. The method of claim 1, wherein:
the part is a composite part designed for construction through composite layup;
the design parameters specify a threshold size for the sensor, a physical alteration characteristic indicative of an effect of the sensor on physical behavior of the composite part, or a combination thereof; and
the manufacturing constraints for the sensor specify a threshold heat tolerance that limits use of a laminate resin pressurization process or composite curing process for construction of the part through composite layup.

5. The method of claim 1, further comprising determining, based on the performed simulation analysis, a signal distortion for the sensor based on geometry of the part, a material used to construct the part, or a combination of both.

6. A system comprising:
a sensor design engine configured to:
access a computer-aided design (CAD) model of a part; and
define a sensor in the CAD model as a component of the part, including by specifying:
design parameters for the sensor;
manufacturing constraints for physical construction of the part including the sensor; and
a signal type produced by the sensor; and
a sensor analysis engine configured to perform a simulation analysis on the part, defined in the CAD model to include the sensor, including digitally simulating operation of the sensor as a component of the part.

7. The system of claim 6, wherein the sensor design engine is configured to define the sensor in the CAD model by accessing a representation of the sensor from a sensor library that stores multiple predefined sensor representations, each with predefined design constraints, manufacturing constraints, and signal types.

8. The system of claim 6, wherein the design parameters comprises a distance-to-surface constraint, a power requirement constraint, or a size threshold; and
sensor design engine is configured to enforce the distance-to-surface constraint, the power requirement constraint, or the size threshold in the CAD model.

9. The system of claim 6, wherein the sensor analysis engine is further configured to determine, based on the performed simulation analysis, a signal distortion for the sensor based on geometry of the part, a material used to construct the part, or a combination of both.

10. The system of claim 6, wherein the part is a composite part designed for construction through composite layup; and
wherein the sensor analysis engine is further configured to determine, based on the performed simulation analysis, improper operation of the sensor based on an orientation of the sensor with fiber orientations of plies in the composite part.

11. The system of claim 6, wherein:
the part is designed for construction through additive manufacturing;
the design parameters specify a threshold size for the sensor, an overhang indicator specifying whether the sensor will create an overhang during construction of the part, an unreachability indicator specifying whether a position of the sensor in the part is unreachable after construction of the part through additive manufacturing, or any combination thereof; and
the manufacturing constraints for the sensor specify a pause point during the construction of the part for physical insertion of the sensor, a temperature constraint to limit the construction of the part through additive manufacturing, a deposition material constraint to limit the construction of the part through additive manufacturing, or any combination thereof.

12. The system of claim 6, wherein:
the part is a composite part designed for construction through composite layup;
the design parameters specify a threshold size for the sensor, a physical alteration characteristic indicative of an effect of the sensor on physical behavior of the composite part, or a combination thereof; and
the manufacturing constraints for the sensor specify a threshold heat tolerance that limits use of a laminate resin pressurization process or composite curing process for construction of the part through composite layup.

13. A non-transitory machine-readable medium comprising instructions that, when executed by a processor, cause a computing system to:
access a computer-aided design (CAD) model of a part;
define a sensor in the CAD model as a component of the part, including by specifying manufacturing constraints for physical construction of the part including the sensor; and
perform a simulation analysis on the part, defined in the CAD model to include the sensor, including digitally simulating operation of the sensor as a component of the part.

14. The non-transitory machine-readable medium of claim 13, wherein:
the part is designed for construction through additive manufacturing; and
the manufacturing constraints for the sensor specify a pause point during the construction of the part for physical insertion of the sensor, a temperature constraint to limit the construction of the part through additive manufacturing, a deposition material constraint to limit the construction of the part through additive manufacturing, or a combination thereof.

15. The non-transitory machine-readable medium of claim 13, wherein:
the part is a composite part designed for construction through composite layup; and
the manufacturing constraints for the sensor specify a threshold heat tolerance that limits use of a laminate resin pressurization process or composite curing process for construction of the part through composite layup.
